(19) United States
(12) Patent Application Publication
(10) Pub. No.: US 2014/0286832 A1
(43) Pub. Date: Sep. 25, 2014

(54) EXHAUST SYSTEM

(71) Applicant: Caterpillar Inc., Peoria, IL (US)

(72) Inventors: Yong Yi, Dunlap, IL (US); Jinhui Sun, Dunlap, IL (US); Arvind Jujare, Peoria, IL (US)

(21) Appl. No.: 14/298,271

(22) Filed: Jun. 6, 2014

(51) Int. Cl. B01D 53/86

(52) U.S. Cl. CPC B01D 53/86
USPC 422/176

(57) ABSTRACT

An exhaust system is provided. The exhaust system includes an exhaust conduit having a protuberance thereon. A reductant injector is provided on the protuberance. The reductant injector is positioned such that an ejection tip of the reductant injector is inclined with respect to a centerline of the exhaust conduit. A baffle assembly is coupled to an inner wall of the exhaust conduit. The baffle assembly is positioned upstream of the ejection tip of the reductant injector. A first plate of the baffle assembly is positioned parallel to the centerline of the exhaust conduit. A second plate of the baffle assembly extends from the first plate. The second plate is positioned angularly with respect to the first plate. The baffle assembly is configured to deflect at least a portion of an exhaust gas flow over the ejection tip of the reductant injector.

### TECHNICAL FIELD

The present disclosure relates to an exhaust system and more specifically to a system for controlling exhaust flow in the exhaust system.

### BACKGROUND

An aftertreatment system is associated with an engine to remove or reduce nitrous oxides (NOx) emissions in an exhaust gas flow. A reductant may be introduced into the exhaust gas flow via an injector positioned upstream of a selective catalytic reduction (SCR) module. The reductant may include a solution containing urea.

Sometimes, the reductant may deposit on an inner wall of the exhaust conduit. Further, the reductant may also deposit on a tip of the injector. The deposit formation on the tip of the injector may affect a reductant dose operation. Hence, there is a need to provide an improved exhaust system design to control deposit formation on the tip of the injector.

U.S. Published Application Number 2012/0144812 discloses a dosing module for an exhaust gas aftertreatment system of a vehicle, which may be used to inject a reducing agent along a flow direction of exhaust gas at a front side of a selective catalyst reduction (SCR) unit. The dosing module may include a dosing main body having a connection portion that may be connected to the SCR unit and an inflow portion into which the exhaust gas flows, an injector that may be disposed at a boss portion that may be mounted on the dosing main body to inject the reducing agent into the dosing main body, and a guide member that may be disposed inside the dosing main body to guide the exhaust gas flowing into the dosing main body along a predetermined route.

### SUMMARY OF THE DISCLOSURE

In one aspect of the present disclosure, an exhaust system is provided. The exhaust system includes an exhaust conduit configured to define a passage for exhaust gas flow therethrough. The exhaust conduit has a protuberance thereon. A reductant injector is provided on the protuberance. The reductant injector is positioned such that an ejection tip of the reductant injector is inclined with respect to a centerline of the exhaust conduit. A baffle assembly is coupled to an inner wall of the exhaust conduit. The baffle assembly is positioned upstream of the ejection tip of the reductant injector. The baffle assembly includes a first plate and a second plate. The first plate is positioned parallel to the centerline of the exhaust conduit. The second plate extends from the first plate. The second plate is positioned angularly with respect to the first plate. A plurality of holes is present on at least one of the first plate and the second plate. The baffle assembly is configured to deflect at least a portion of the exhaust gas flow over the ejection tip of the reductant injector.

Other features and aspects of this disclosure will be apparent from the following description and the accompanying drawings.

### BRIEF DESCRIPTION OF THE DRAWINGS

FIG. 1 is a block diagram of an exemplary aftertreatment system, according to an embodiment of the present disclosure;

FIG. 2 is a perspective view of a reductant injector installed on an exhaust conduit;

FIG. 3 is a perspective view of a baffle assembly; and

FIG. 4 is a schematic view of the exhaust conduit including the baffle assembly therein.

### DETAILED DESCRIPTION

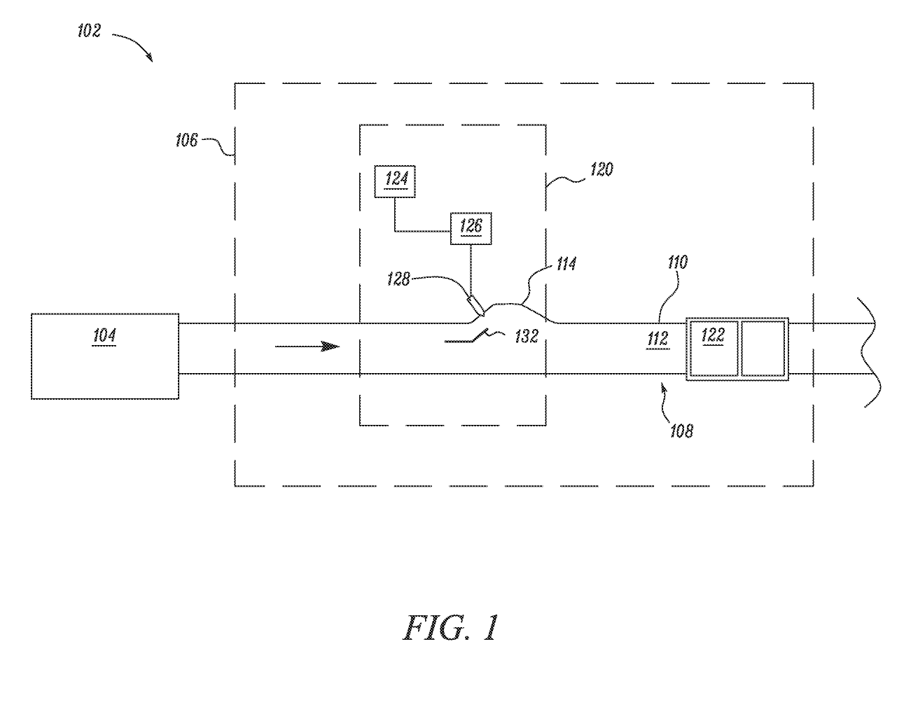

FIG. 1 is a block diagram of an exemplary engine system 102, according to one embodiment of the present disclosure. The engine system 102 includes an engine 104. In one embodiment, the engine 104 includes a diesel powered engine. In other embodiments, the engine 104 may include any internal combustion engine known in the art including, but not limited to, a gasoline powered engine, a natural gas powered engine or a combination thereof. The engine 104 may include other components (not shown) such as a fuel system, an intake system, a drivetrain including a transmission system and so on. The engine 104 may be used to provide power to any machine including, but not limited to, an on-highway truck, an off-highway truck, an earth moving machine, an electric generator, and so on. Further, the engine system 102 may be associated with any industries including, but not limited to, transportation, construction, agriculture, forestry, power generation and material handling.

The engine system 102 includes an exhaust aftertreatment system, hereinafter referred to as aftertreatment system 106, fluidly connected to an exhaust manifold of the engine 104. The aftertreatment system 106 is configured to treat an exhaust gas flow exiting the exhaust manifold of the engine 104. The exhaust gas flow contains emission compounds that may include Nitrogen Oxides (NOx), unburned hydrocarbons, particulate matter and/or other compounds. The aftertreatment system 106 is configured to treat and reduce NOx, unburned hydrocarbons, particulate matter and/or other compounds of the emissions prior to the exhaust gas flow exiting the engine system 102.

The aftertreatment system 106 may include an exhaust conduit 108 fluidly connected to the exhaust manifold. The exhaust conduit 108 defines a centerline C-C′. The exhaust conduit 108 includes a wall 110 defining an exhaust passage 112 therein. The exhaust passage 112 is configured to receive the exhaust gas flow. The exhaust conduit 108 may include a protuberance 114 on the wall 110. The shape of the protuberance 114 may vary. For example, the protuberance 114 may have a dome or bump-like appearance. The protuberance 114 may be defined by inclined sidewalls 202, 204 which are angularly positioned with respect to the centerline C-C′.

A selective catalytic reduction (SCR) module 122 may be coupled to the exhaust conduit 108. The SCR module 122 is configured to reduce a concentration of NOx present in the exhaust gas flow. The SCR module 122 may include a catalyst for facilitating the reaction, reduction, or removal of NOx from the exhaust gas as the flow passes through the SCR module 122. The SCR module 122 may have a honeycomb or other structure made from or coated with an appropriate material. The material may be an oxide, such as vanadium oxide or tungsten oxide, coated on an appropriate substrate, such as titanium dioxide. The SCR module 122 may have a monolithic structure or may include multiple banks. The aftertreatment system 106 may additionally include other components such as, a Diesel Particulate Filter (DPF), a Diesel Oxidation Catalyst (DOC), NOx sensors, and so on. The components and connections of the aftertreatment system 106 shown herein are exemplary and do not limit the scope of the present disclosure.

Referring to FIG. 1, a reductant supply module 120 is associated with the exhaust conduit 108. The reductant supply module 120 may include a storage tank 124, a pump 126 and a reductant injector 128. The storage tank 124 is fluidly connected to the reductant injector 128 through the pump 126 to dispense a reductant into the exhaust conduit 108. The reductant may be a fluid such as a Diesel Exhaust Fluid (DEF), comprising urea solution. Alternatively, the reductant may include ammonia or any other reducing agent. Parameters related to the storage tank 124 such as size, shape, location, and material used may vary according to system design and requirements. The pump 126 is configured to pressurize and selectively deliver the reductant from the storage tank 124 in to the exhaust conduit 108 through the reductant injector 128. The pump 126 may be any pump known in the art including, but not limited to, a piston pump, a centrifugal pump, and so on.

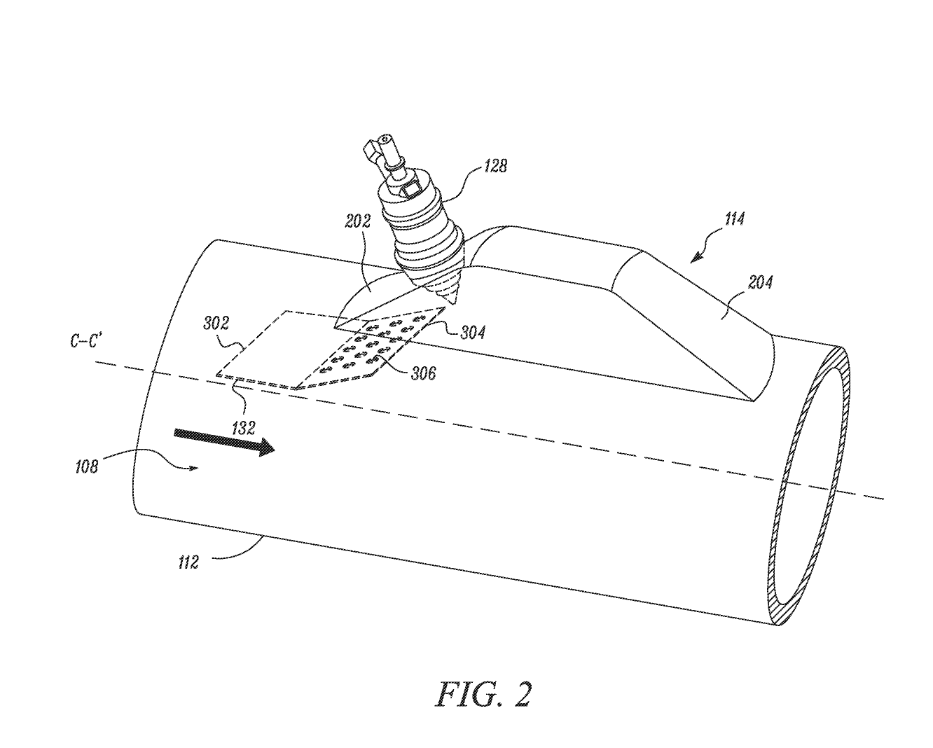

Further, the reductant injector 128 is mounted on the side wall 202 of the protuberance 114 provided on the exhaust conduit 108. The reductant injector 128 may be mounted in a manner such that the reductant injector 128 may dispense the reductant in a direction inclined to the centerline C-C′ of the exhaust conduit 108. As shown in FIG. 2, an ejection tip 206 of the reductant injector 128 may be in communication with the exhaust passage 112.

The present disclosure relates to a baffle assembly 132 disposed within the exhaust conduit 108 and in relation to the ejection tip 206 of the reductant injector 128. The baffle assembly 132 is positioned upstream of the ejection tip 206 of the reductant injector 128, such that the baffle assembly does not obstruct a flow of the reductant from the ejection tip 206. The baffle assembly 132 is configured to deflect at least a portion of the exhaust gas flow towards the ejection tip 206. The baffle assembly 132 may be coupled to an inner wall of the exhaust conduit 108. The baffle assembly 132 may be attached to the inner wall of the exhaust conduit 108 using any known fastening methods (not shown) including, but not limited to, welding, brazing, riveting, brackets and bolting. The attachment of the baffle assembly 132 to the exhaust conduit 108 may be such as to provide minimum interference to fluid flow.

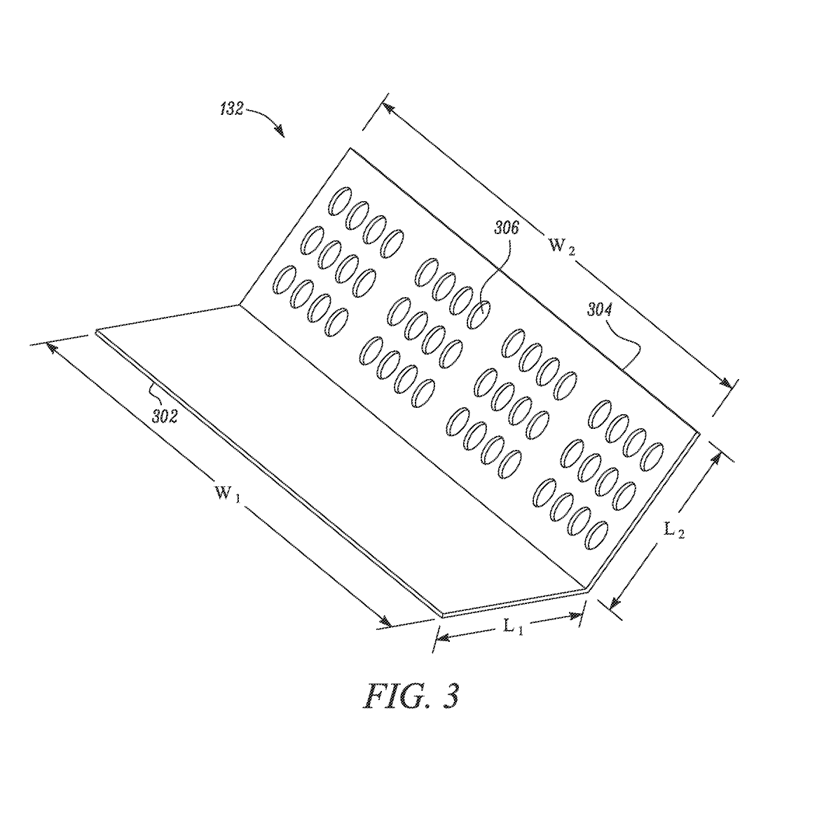

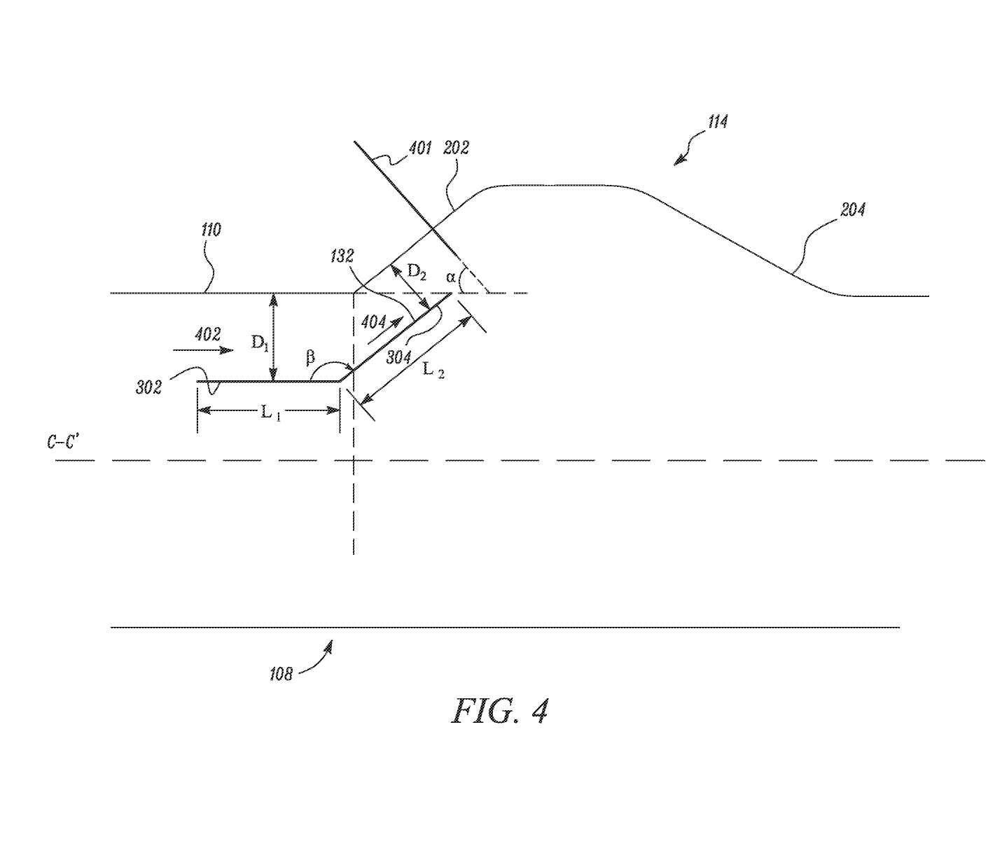

FIG. 3 illustrates a perspective view of the baffle assembly 132. FIG. 4 illustrates a schematic view of the baffle assembly 132 positioned within the exhaust conduit 108. For the purpose of simplicity, the reductant injector 128 and the ejection tip 206 is not shown in FIG. 4. A direction at which the reductant is introduced within the exhaust conduit 108 is represented by an injection vector 401. The injection vector 401 is indicative of an axis of the ejection tip 206 of the reductant injector 128. The ejection tip 206 represented by the injection vector 401 may be positioned at an angle ‘α’ with respect to the centerline C-C′ of the exhaust conduit 108.

Referring to FIGS. 3 and 4, the baffle assembly 132 has a first plate 302 and a second plate 304. The first plate 302 may be positioned parallel to the centerline C-C′ of the exhaust conduit 108. The second plate 304 extends from the first plate 302 and may be positioned at an angle ‘β’ with respect to the first plate 302. In one embodiment, the angle ‘β’ is in a range approximately between 130 degree and 140 degree. In another embodiment, the angle ‘β’ is in a range approximately between 115 degree and 135 degree. In yet another embodiment, the angle β is in a range approximately between 140 degree and 200 degree. These ranges are exemplary and do not limit the scope of the present disclosure.

As shown in FIG. 3, one or more holes 306 may be provided on the baffle assembly 132 to provide a passage for flow of exhaust gas therethrough. In one embodiment, the first plate 302 may include the holes 306. In another embodiment, the second plate 304 may include the holes 306. In yet another embodiment, both the first plate 302 and the second plate 304 may include one or more holes 306. In the illustrated embodiment, the holes 306 are provided on the second plate 304. Each of the holes 306 may be spaced apart from each other forming a pattern on the respective first or second plate 302, 304 of the baffle assembly 132. It may be apparent to a person of ordinary skill in the art that parameters related to the holes 306 including, but not limited to, number, shape, size, location and spacing between the holes 306 may vary as per system design and requirements. The first and second plates 302, 304 may have a planar configuration.

Referring to FIG. 4, the first plate 302 may be positioned at distance D₁ from the wall 110 of the exhaust conduit 108. Therefore, the portion of the exhaust gases may be channelized and directed in a direction 402 between the wall 110 of the exhaust conduit 108 and the first plate 302 of the baffle assembly 132. In one example, the distance D₁ between the wall 110 of the exhaust conduit 108 and the first plate 302 may lie in range approximately between 1″ and 2″. The second plate 304 may be positioned at a distance D₂ from the sidewall 202 of the protuberance 114. In one example, the distance D₂ may lie in range approximately between 1″ and 2″. The exhaust gases deflected by the first plate 302 may be directed in a direction 404 between the wall 110 of the exhaust conduit 108 and the second plate 304. This may in turn cause the exhaust gas to flow over the ejection tip 206 of the reductant injector 128. A flow velocity of the exhaust gas around the ejection tip 206 may be increased. The improved flow velocity of the exhaust gas may flush the reductant that may impinge and/or deposit on the ejection tip 206.

A length L₁ of the first plate 302 of the baffle assembly 132 may vary. In one example, the length L₁ may vary approximately between 0.5″ and 2.5″. A length L₂ of the second plate 304 of the baffle assembly 132 may vary. In one example, the length L₂ may vary approximately between 0.5″ and 2.5″. Further, a width W₁ of the first plate 302 may be equal to that of an inner diameter of the exhaust conduit 108. A width W₂ of the second plate 304 may be equal to or lesser than the width W₁ of the first plate 302. This may allow for attachment of the baffle assembly 132 within the exhaust conduit 108. In one example, the width W₂ is less than the width W₁ of the first plate 302, such that a substantial portion of the second plate 304 is positioned close to the ejection tip 206 of the reductant injector 128. In another example, as illustrated in FIG. 3, the width W₂ of the second plate 304 is equal to the width W₁ of the first plate 302.

A person of ordinary skill in the art will appreciate that the parameters associated with the baffle assembly 132 and its positioning within the exhaust conduit 108 described herein are exemplary and may vary based on the application. The ranges specified herein are exemplary and do not limit the scope of the present disclosure.

The baffle assembly 132 may be made of a metal or an alloy such as, for example, stainless steel. In other embodiments, the baffle assembly 132 may be made of any polymer known in the art. The baffle assembly 132 may be formed by any known manufacturing process such as stamping, punching, any other hot and/or cold working methods, sheet metal working method and so on.

### INDUSTRIAL APPLICABILITY

In aftertreatment systems, during injection of the reductant and/or during mixing of the exhaust gas and the reductant, the reductant may contact an inner surface of the exhaust conduit or the reductant injector. The reductant may form deposits on the inner surface of the exhaust conduit and/or the reductant injector. Also, in the aftertreatment systems employing the reductant injector that sprays the reductant at discrete intervals, the reductant may leak when the reductant injector is not operational. Due to high temperatures inside the exhaust conduit, water from the reductant may be evaporated resulting in formation of deposits. Further, there may be non-uniform distribution of the reductant inside the exhaust conduit for different flow rate conditions of the exhaust gas flow.

The present disclosure provides an exhaust system including the reductant injector 128 positioned at the angle α within the protuberance 114, as well as the baffle assembly 132 provided therewith. The baffle assembly 132 is provided within the exhaust passage 112 of the exhaust conduit 108 in cooperation with the ejection tip 206 of the reductant injector 128. The baffle assembly 132 may create a backpressure in the exhaust gas flow on an upstream side of the baffle assembly 132. A resistance may be provided by each of the plurality of holes 306 to the exhaust gas flow.

The design of the baffle assembly 132 may provide vortices for the mixture of the reductant and the exhaust gas flow on a downstream side of the ejection tip 206. The vortices may create turbulence in the mixture of the reductant and the exhaust gas flow. The turbulence may result in uniform mixing of the reductant and the exhaust gas flow. Additionally, the turbulence may result in splitting of the reductant droplets into finer droplets. This in turn may improve evaporation rate of the reductant leading, allowing for uniform mixing of the fine reductant droplets with the exhaust gas flow. There may also be a reduction in deposit formation on the ejection tip 206, the baffle assembly 132 and/or the wall of the exhaust conduit 108.

Further, the baffle assembly 132 may increase the flow velocity of the exhaust gas adjacent to the wall 110 of the exhaust conduit 108. As a result, a pressure drop in the exhaust conduit 108 across the baffle assembly 132 may be reduced. The improved flow velocity of the exhaust gas may flush out the reductant that may impinge and/or deposit on the wall 110 of the exhaust conduit 108 leading to reduced deposits and material wastage.

The baffle assembly 132 may be calibrated to be used in different configurations of the reductant injector 128 and/or the exhaust conduit 108. For example, the baffle assembly 132 may be modified and calibrated based on location and/or orientation of the reductant injector 128, length of the exhaust conduit 108, diameter of the exhaust conduit 108, allowable pressure drop in the exhaust conduit 108 and so on. Further, the baffle assembly 132 may provide reduced reductant depositions, ease in manufacturability and reduced weight leading to overall reduction in system weight.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An exhaust system comprising:
an exhaust conduit configured to define a passage for exhaust gas flow therethrough, the exhaust conduit having a protuberance thereon;
a reductant injector provided on the protuberance, the reductant injector positioned such that an ejection tip of the reductant injector is inclined with respect to a centerline of the exhaust conduit; and
a baffle assembly coupled to an inner wall of the exhaust conduit, the baffle assembly positioned upstream of the ejection tip of the reductant injector, the baffle assembly comprising:
a first plate positioned parallel to the centerline of the exhaust conduit; and
a second plate extending from the first plate, the second plate positioned angularly with respect to the first plate,
wherein at least one of the first plate and the second plate include a plurality of holes thereon and the baffle assembly is configured to deflect at least a portion of the exhaust gas flow over the ejection tip of the reductant injector.
